(19) United States
(12) Patent Application Publication
(10) Pub. No.: US 2009/0293364 A1
(43) Pub. Date: Dec. 3, 2009

(54) SOFT SUICIDE PREVENTION DOOR

(76) Inventors: Lisa D. GARSTAD, Sheridan, WY (US); Jacklyn K. Vanmark, Sheridan, WY (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/471,765

(22) Filed: May 26, 2009

Related U.S. Application Data
(60) Provisional application No. 61/057,020, filed on May 29, 2008.

(51) Int. Cl. E06B 7/00; E05D 5/02; E05B 1/00; E05C 19/00

(52) U.S. Cl. 49/70; 16/387; 16/412; 292/2

(57) ABSTRACT

The invention is directed to a soft suicide prevention door. In one embodiment, the soft suicide prevention door includes a door frame formed of a tubing component, a fabric material disposed on opposed radial ends of the tubing component for forming a door body including an inner layer and an outer layer, a foam core component disposed between the inner layer and the outer layer, and, a hinge component attached to a side of the door body for forming a hinge when attached to a complementary attachment component attached to a door jam. The soft suicide prevention door is removable from the door jam when a predetermined weight is applied to release the hinge component from the complementary attachment component.

### CROSS-REFERENCE TO RELATED APPLICATION

This application claims the benefit of provisional patent application U.S. Ser. No. 61/057,020, filed May 29, 2008, which is expressly incorporated herein by reference.

### BACKGROUND OF INVENTION

a. Field of Invention

The invention relates generally to suicide prevention doors, and, more particularly, to a soft suicide prevention door that is designed to provide privacy while not providing anchor points for suicide, particularly for bathroom doors used in mental health or other facilities.

b. Description of Related Art

As is known in the art, mental health facilities are required to use fixtures and objects that are resistant to use in a suicide attempt. With bathroom doors for example, the doors may be required to have single piano-type hinges, no anchor points, no locking knobs, no self closure mechanisms, and other additional requirements.

Existing suicide prevention doors, such as SER (Suicide Event Resistant) doors, include a hard surface with four main components held together with tamper resistant screws. The main body of the SER door may include two pieces of particle board that sandwich a third top section which is on a ball-type hinge which allows the door to fall if any pressure is applied. Due to the sandwich construction and material used, the SER door can be pulled apart and may be used as a weapon. While the use of a ball-type hinge may meet industry standards for such doors, the hinge can nevertheless be used for an anchor point for a suicide attempt. The SER door also has several sections and openings for dirt and other contaminants to enter the door body and thus be a source of infection, especially if the door has been impacted by a mental health patient. Moreover, because of the door working mechanism, the door can be subject to recurring maintenance and operational testing requirements.

Accordingly, there remains a need for a suicide prevention door which meets and exceeds the aforementioned industry standards for such doors and related fixtures for use in a mental health facility. There also remains a need for a suicide prevention door which is economical to manufacture, install and service, and which is further robust in design for long term use.

### SUMMARY

The suicide prevention door of the invention may provide one or more of the following advantages:

(1) provides a soft suicide prevention door that is designed to provide privacy while not providing anchor points for suicide, particularly for bathroom doors used in mental health facilities;

(2) provides a soft suicide prevention door that meets and exceeds industry standards for such known doors and related fixtures for use in a mental health facility;

(3) provides a soft suicide prevention door that is economical to manufacture, install, and service, and that is robust in design for long term use;

(4) provides a soft suicide prevention door that uses VELCRO (or a hook and loop attachment like VELCRO), plastic, magnets, or other suitable means as the door hinge or door latch, and also uses a plastic or foam packing sheet, insulation material, and/or PVC (polyvinyl chloride) tubing to provide adequate structural strength while also providing sufficient flexibility to give and bend when pressure is applied, or be detachable from the door;

(5) provides a soft suicide prevention door comprised of materials that meet fire and safety requirements for such doors and such fixtures;

(6) provides a soft suicide prevention door that may be readily disinfected after use to meet adequate cleanliness standards; and

(7) provides a soft suicide prevention door that may be used as a suicide prevention door, a room door, a bathroom door, a shower door, for evacuation during an emergency, as a protection barrier, as a self defense tool, and for use in a mental health facility, or any facility with a high risk of suicide.

In an embodiment of the invention, there is provided a soft suicide prevention door. The soft suicide prevention door may include a door frame formed of a tubing component, a fabric material disposed on opposed radial ends of the tubing component for forming a door body including an inner layer and an outer layer, a foam core component disposed between the inner layer and the outer layer, and a hinge component attached to a side of the door body for forming a hinge when attached to a complementary attachment component attached to a door jam. The soft suicide prevention door may be removable from the door jam when a predetermined weight is applied to release the hinge component from the complementary attachment component.

For the soft suicide prevention door described above, the tubing component may include polyvinyl chloride (PVC) tubing. The fabric material may be selected from the group including lightweight vinyl and vinyl laminated polyester. Alternatively, the fabric material may include graphics laminated onto the fabric material. In an embodiment, the fabric material may be laminated to a front side and a back side of the foam core component and any seams of the fabric material are sealed around the foam core component with a waterproof, tamper proof sealant. In an embodiment, the foam core component may be selected from the group including rigid insulation foam and rigid plastic packing material. The foam core component may be waterproof, infection control safe, sufficiently firm, and flame resistant. The fabric material may also be sewn to encapsulate the foam.

For the soft suicide prevention door described above, in an embodiment, the hinge component may be selected from the group including VELCRO strips, plastic and VELCRO attached with plastic rivets, and magnets, or sewn directly to the door. In an embodiment, the complementary attachment component may be selected from the group including complementary VELCRO strips, webbed plates having complementary VELCRO strips attached to the webbed plates, metal plates having complementary VELCRO strips attached to the metal plates, and magnets. In an embodiment, the soft suicide prevention door may further include a door handle made of the fabric material and attached to the outer layer of the door body. In an embodiment, the soft suicide prevention door may further include a door latch component comprising one or more VELCRO strips, wherein the door latch component is attached to the inner layer of the door body. In an embodiment, the soft suicide prevention door has a use selected from the group including use as a suicide prevention door, use as a room door, use as a bathroom door, use as a shower door, use for evacuation during an emergency, use as a protection barrier, use as a self defense tool, and use in a mental health facility, or any setting that requires soft components for safety.

In another embodiment of the invention, there is provided a soft suicide prevention door. The soft suicide prevention door may include a door frame formed of a rigid insulation foam core component covered by a lightweight fabric material, and, a hinge component attached to a side of the door frame for forming a hinge when attached to a complementary attachment component attached to a door jam. The soft suicide prevention door may be removable from the door jam when a predetermined weight is applied to release the hinge component from the complementary attachment component.

For the soft suicide prevention door described above, the lightweight fabric material may be selected from the group including lightweight vinyl and vinyl laminated polyester. In an embodiment, the lightweight fabric material may include graphics laminated onto the lightweight fabric material. In an embodiment, the rigid insulation foam core component may be waterproof, infection control safe, sufficiently firm, and flame resistant. In an embodiment, the hinge component may be selected from the group including VELCRO strips, plastic and VELCRO attached with plastic rivets, and magnets. In an embodiment, the complementary attachment component may be selected from the group including complementary VELCRO strips, webbed plates having complementary VELCRO strips attached to the webbed plates, metal plates having complementary VELCRO strips attached to the metal plates, and magnets.

In another embodiment of the invention, there is provided a soft suicide prevention door having no anchor points for a human to commit suicide. The soft suicide prevention door may include a door frame formed of a polyvinyl chloride tubing component, a lightweight vinyl fabric material disposed on opposed radial ends of the tubing component for forming a door body including an inner layer and an outer layer, a foam core component disposed between the inner layer and the outer layer, wherein the foam core component is selected from the group comprising rigid insulation foam and rigid plastic packing material, a hinge component comprising one or more VELCRO strips attached to a side of the door body for forming a hinge when attached to a complementary attachment component comprising one or more complementary VELCRO strips attached to a door jam, a door handle made of the lightweight vinyl fabric material and attached to the outer layer of the door body, and, a door latch component comprising one or more VELCRO strips, wherein the door latch component is attached to the inner layer of the door body. The soft suicide prevention door may be removable from the door jam when a predetermined weight is applied to release the hinge component from the complementary attachment component.

For the soft suicide prevention door described above, the door may have a use selected from the group including use as a suicide prevention door, use as a room door, use as a bathroom door, use as a shower door, use for evacuation during an emergency, use as a protection barrier, use as a self defense tool, and use in a mental health facility, or any setting that requires soft components for safety.

The features, functions, and advantages that have been discussed can be achieved independently in various embodiments of the invention or may be combined in yet other embodiments further details of which can be seen with reference to the following description and drawings.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is an illustration of a front view of an embodiment of a suicide prevention door according to the present invention;

FIG. 2 is an illustration of a close-up view of the back of the suicide prevention door of FIG. 1;

FIG. 3 is an illustration of a close-up view of a tubing component of the suicide prevention door of FIG. 1;

FIG. 4 is an illustration of a close-up view of a hinge component of the suicide prevention door of FIG. 1;

FIG. 5 is an illustration of a cut-away back view of another embodiment of a suicide prevention door according to the present invention;

FIG. 6 is an illustration of a close-up view of a foam core component of the suicide prevention door of FIG. 5;

FIG. 7 is an illustration of a front view of another embodiment of a suicide prevention door according to the present invention;

FIG. 8 is an illustration of a close-up left side perspective view of the suicide prevention door of FIG. 7;

FIG. 9 is an illustration of a close-up view of a hinge component of the suicide prevention door of FIG. 7;

FIG. 10 is an illustration of a close-up view of a door handle of the suicide prevention door of FIG. 7;

FIG. 11 is an illustration of a close-up view of a complementary latch contact for use with the suicide prevention door of FIG. 7;

FIG. 12 is an illustration of a back view of the suicide prevention door of FIG. 7;

FIG. 13 is an illustration of a first tear away use of the suicide prevention door of FIG. 7;

FIG. 14 is an illustration of a second tear away use of the suicide prevention door of FIG. 7;

FIG. 15 is an illustration of a third tear away use of the suicide prevention door of FIG. 7;

FIG. 16 is an illustration of an evacuation use of the suicide prevention door of FIG. 7;

FIG. 17 is an illustration of a mat use of the suicide prevention door of FIG. 7;

FIG. 18 is an illustration of a protection use of the suicide prevention door of FIG. 7;

FIG. 19 is an illustration of a self defense use of the suicide prevention door of FIG. 7;

FIG. 20 is an illustration of another self defense use of the suicide prevention door of FIG. 7;

FIG. 21 is an illustration of a front perspective view of another embodiment of a suicide prevention door according to the present invention;

FIG. 22 is an illustration of a close-up view of a front upper corner of the suicide prevention door of FIG. 21;

FIG. 23 is an illustration of a close-up view of a hinged side of the suicide prevention door of FIG. 21;

FIG. 24 is an illustration of a close-up side cutaway view of another embodiment of a suicide prevention door that is a variation of the suicide prevention door of FIG. 21;

FIG. 25 is an illustration of a front perspective view of another embodiment of a suicide prevention door according to the present invention;

FIG. 26 is an illustration of a close-up view of a hinged side of the suicide prevention door of FIG. 25;

FIG. 27 is an illustration of a close-up view of a side lower corner of the suicide prevention door of FIG. 25;

FIG. 28 is an illustration of a close-up view of a back side of the suicide prevention door of FIG. 25;

FIG. 29 is an illustration of a close-up view of a door latch component of the suicide prevention door of FIG. 25;

FIG. 30 is an illustration of a close-up view of a hinged side and complementary attachment component for the suicide prevention door of FIG. 25; and,

FIG. 31 is an illustration of a close-up view of a complementary attachment component for the suicide prevention door of FIG. 25.

### DETAILED DESCRIPTION

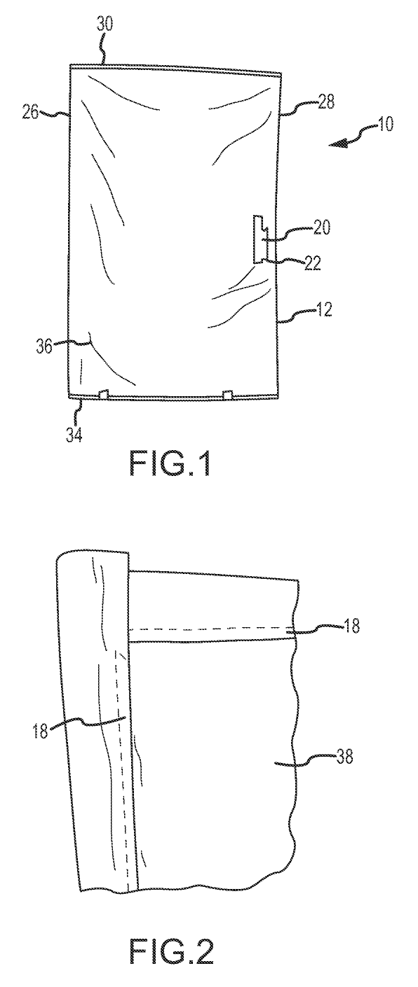

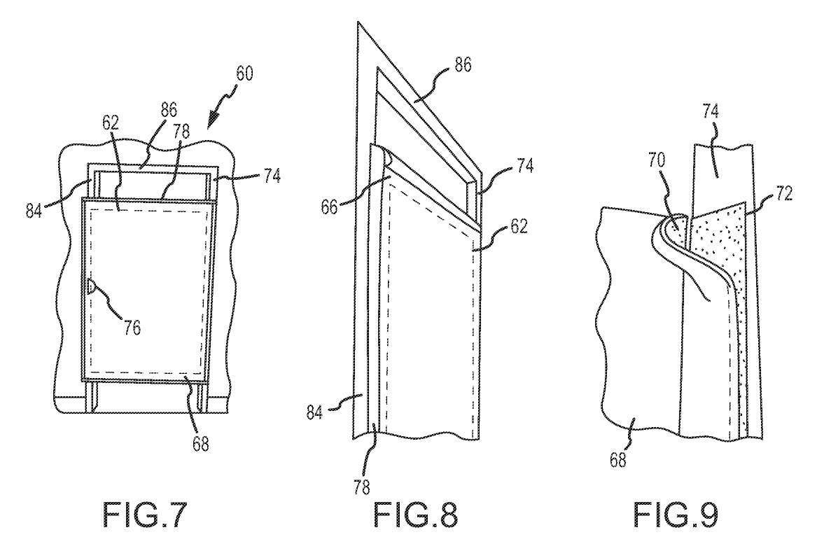

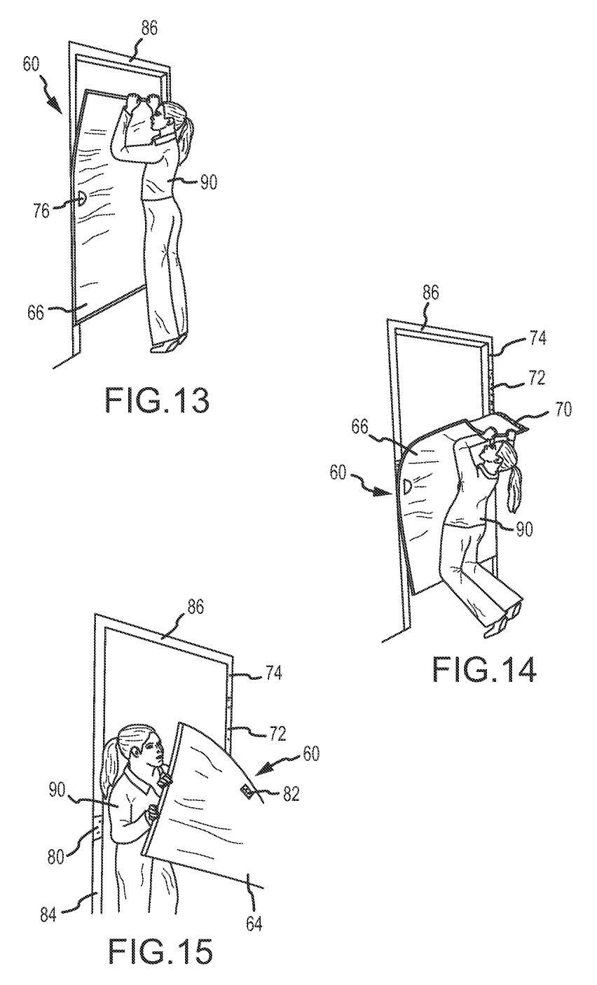

Referring now to the drawings wherein like reference numerals designate corresponding parts throughout the several views, FIGS. 1-12 and 21-31 illustrate various embodiments of suicide prevention doors according to the present invention, and FIGS. 13-20 illustrate various uses of the suicide prevention doors of FIGS. 1-12 and 21-31, and particularly, the embodiment of FIGS. 7-12.

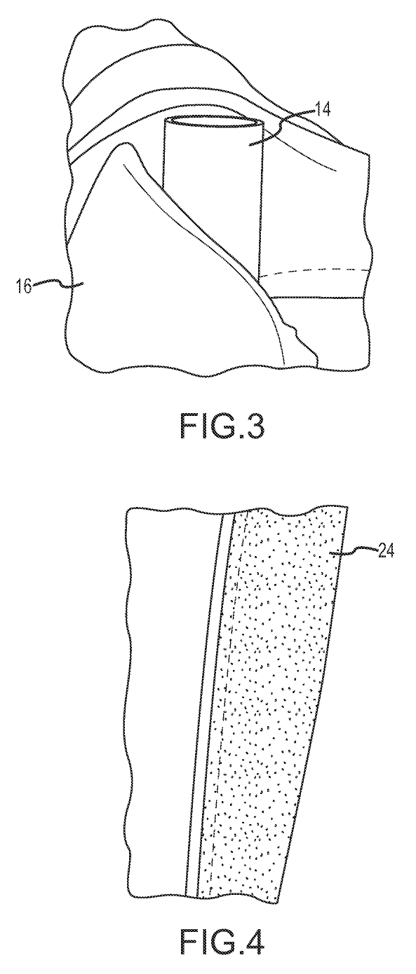

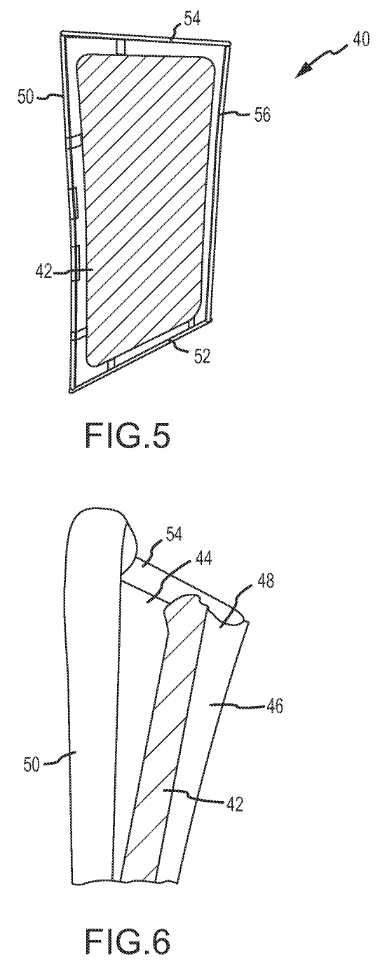

FIG. 1 is an illustration of a front view of an embodiment of a suicide prevention door 10 according to the present invention. Suicide prevention door 10 may generally include a frame 12 having a first side 26, an opposite second side 28, a top 30, and a bottom 34. As readily evident, door 10 may be installed on either side of frame 12. Frame 12 may be constructed of a tubing component 14 (see FIG. 3), such as, for example, one-half inch thick plumbing type PVC (polyvinyl chloride) tubing or another suitable tubing for securing a first suitable wear resistant fabric material 16 (see FIG. 3), such as a lightweight vinyl, vinyl laminated polyester, or other suitable lightweight material. Wear resistant fabric material 16 may include front 36 (see FIG. 1) and a back 38 (see FIG. 2), and may be secured to tubing component 14 by stitching 18 (see FIG. 2). FIG. 2 is an illustration of a close-up view of back 38 of the suicide prevention door of FIG. 1. FIG. 3 is an illustration of a close-up view of tubing component 14 of suicide prevention door 10 of FIG. 1. Suicide prevention door 10 may further comprise a door handle 20 comprised of a second suitable wear resistant fabric material 22 (see FIG. 1), such as a lightweight vinyl or other suitable lightweight material, and may be attached or taped to front 36 of door 10 as shown. In an alternative to handle 20, a small piece of VELCRO may be wrapped around the edge of the door and a small amount may be left unstitched for a handle on both the inside and outside of the door. FIG. 4 is an illustration of a close-up view of a hinge component 24 of suicide prevention door 10 of FIG. 1. Hinge component 24 may comprise VELCRO, plastic and VELCRO attached to the suicide prevention door with plastic rivets, magnets, or other suitable hinge components. Hinge component 24 may be attached to one side of suicide prevention door 10. A complementary VELCRO strip (not shown) may be attached to a door jam (not shown). VELCRO may be sewn on the appropriate side of the hinge component based on a desired door installation choice. In an exemplary embodiment, door 10 may have three hinges made with plastic and VELCRO that may be attached to door 10 with plastic rivets. In another embodiment, VELCRO may be attached or sewn onto plates (not shown) made of lightweight webbed material, lightweight metal, or another suitable material, and the plates may be attached to the door jam (not shown) or door frame (not shown) with tamper proof screws (not shown) so that the VELCRO does not continually pull off the door jam or door frame.

FIG. 5 is an illustration of a cut-away back view of another embodiment of a suicide prevention door 40 having a foam core component 42 according to the present invention. Suicide prevention door 40 comprises a first side 50 and an opposite second side 56, a top 54 and a bottom 52, and a door handle (not shown). FIG. 6 is an illustration of a close-up view of foam core component 42 of suicide prevention door 40 of FIG. 5. Foam core component 42 may comprise a suitably rigid insulation foam type material, a lighter weight foam, or another suitable foam component, and may be disposed or coupled between an inner layer 44 and an outer layer 46 of fabric material 48 for providing stability to suicide prevention door 40. Fabric material 48 may comprise a lightweight vinyl, vinyl laminated polyester, or other suitable lightweight material. As shown in FIG. 6, foam core component 42 and outer layer 46 of fabric material 48 are shown pulled away from first side 50 and top 54 of suicide prevention door 40. The fabric material, such as vinyl, may be laminated or adhered to both sides of the foam core component, and the seams of the fabric material may be sealed with a waterproof, tamper proof sealant. The foam core component is preferably waterproof, infection control safe, sufficiently firm, and flame resistant. If needed, the foam core component may be wrapped with a lightweight batting material (not shown) to allow the foam core component to fit snugly within the fabric material with little or no movement.

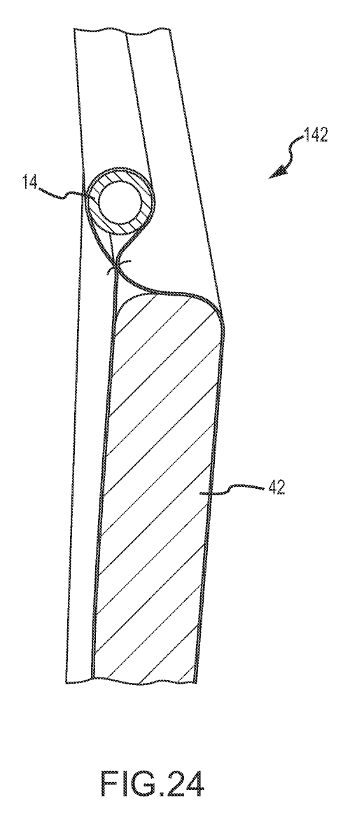

FIG. 7 is an illustration of a front view of another embodiment of a suicide prevention door 60 according to the present invention. Soft suicide prevention door 60 may comprise a door frame 78 formed of a tubing component 14 (see FIGS. 3, 24). Tubing 14 may comprise one-half inch thick plumbing type PVC (polyvinyl chloride) tubing or another suitable tubing. Soft suicide prevention door 60 further comprises a fabric material 68 disposed on opposed radial ends of the tubing component for forming a door body including an inner layer 64 (see FIG. 12) and an outer layer 66 (see FIG. 8). Fabric material 68 may comprise a commercial lightweight vinyl, COVER LITE, vinyl laminated polyester, or another suitable lightweight material for providing stability to suicide prevention door 60. Soft suicide prevention door 60 may further comprise a foam core component 62 disposed between inner layer 64 and outer layer 66 of fabric material 68. Foam core component 62 may comprise a rigid plastic packing type material, a rigid insulation foam type material, or another suitable foam core component. Preferably, the foam core component comprises a rigid plastic packing type material sandwiched between inner layer 64 (see FIG. 12) and outer layer 66 (see FIG. 8) of fabric material 68 (see FIG. 7). The fabric material, such as vinyl, may be laminated or adhered to both sides of the rigid plastic packing type material, and the seams of the fabric material may be sealed with a waterproof, tamper proof sealant. The foam core component is preferably waterproof, infection control safe, sufficiently firm, and flame resistant. If needed, the foam core component may be wrapped with a lightweight batting material (not shown) to allow the foam core component to fit snugly within the fabric material with little or no movement. Optionally, with the use of rigid plastic packing type material 62, tubing 14 may be eliminated if the size of suicide prevention door 60 is small enough to have sufficient rigidity without the use of tubing 14. As shown in FIG. 7, suicide prevention door 60 may be attached to a first door jam 84 and a second door jam 74 on the outside of door frame 86, so that suicide prevention door 60 may swing open and closed as a conventional door would open and close. In another embodiment the door may be attached to the inside of the door frame, and the door leverages itself against the door frame to tear away from the door frame. There may be open space above and below suicide prevention door 60. FIG. 8 is an illustration of a dose-up left side perspective view of suicide prevention door 60 of FIG. 7.

Soft suicide prevention door 60 further comprises a hinge component 70 attached to a side of the door body for forming a hinge when attached to a complementary attachment component 72 attached to a door jam 74 (see FIG. 9). FIG. 9 is an illustration of a close-up view of hinge component 70 of suicide prevention door 60 of FIG. 7. Hinge component 70 may comprise VELCRO strips attached to fabric material 68 of the suicide prevention door. VELCRO may be sewn on the appropriate side of hinge component 70 based on a desired door installation choice. Hinge component 70 may also comprise plastic and VELCRO attached to the suicide prevention door with plastic rivets, may comprise magnets, or may comprise other suitable hinge components. For example, door 60 may have three hinges made with plastic and VELCRO that may be attached to the door with plastic rivets. Hinge component 70 may be attached to the complementary or corresponding attachment component 72 attached to door jam 74. Preferably, complementary or corresponding attachment component 72 comprises complementary or corresponding VELCRO strips or another suitable attachment component. The VELCRO strips and complementary VELCRO strips may be cut to a predetermined length, such as 6 inches, for preventing use of the VELCRO strips as a rope or another such object for facilitating a suicide, such as if the VELCRO used for the door hinge was formed of a long VELCRO strip. The soft suicide prevention door is removable from the door jam when a predetermined weight is applied to release the hinge component from the complementary attachment component.

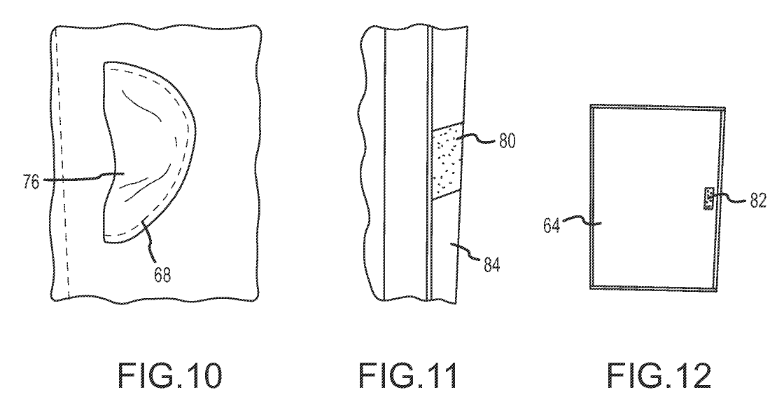

Suicide prevention door 60 may further comprise a door handle 76 preferably made of fabric material 68 and attached to outer layer 66 of the door body. FIG. 10 is an illustration of a close-up view of door handle 76 of suicide prevention door 60 of FIG. 7. Door handle 76 is preferably stitched or adhered onto fabric material 68 and formed as shown. FIG. 11 is an illustration of a close-up view of a complementary latch contact 80 attached to first door jam 84 for use with suicide prevention door 60 of FIG. 7. Complementary latch contact 80 may comprise one or more complementary VELCRO strips or another suitable complementary latch contact. FIG. 12 is an illustration of inner layer 64 of suicide prevention door 60 of FIG. 7 showing door latch component 82 on suicide prevention door 60. Door latch component 82 may comprise one or more VELCRO strips. In another embodiment, VELCRO may be attached or sewn onto plates (not shown) made of lightweight webbed material, lightweight metal, or another suitable material, and the plates may be attached to one or both of door jams 74, 84 or inside the door frame (not shown) with tamper proof screws (not shown) so that the VELCRO does not continually pull off the door jams or door frame.

Referring next to FIGS. 13-20, various uses of embodiments of the suicide prevention doors of the invention, and in particular, suicide prevention door 60 of FIGS. 7-12 are illustrated. FIG. 13 is an illustration of a first tear away use or function of suicide prevention door 60 of FIG. 7. FIG. 13 shows a patient 90 standing against outer layer 66 of suicide prevention door 60 and beginning to tear door 60 away from door frame 86. The first tear away use or function is shown from outside door frame 86. FIG. 14 is an illustration of a second tear away use or function of suicide prevention door 60 of FIG. 7. FIG. 14 shows patient 90 bending against outer layer 66 of suicide prevention door 60 and more fully tearing the door away from door frame 86. Hinge component 70 on door 60 is torn away from complementary attachment component 72 on second door jam 74. The second tear away use or function is shown from outside door frame 86. FIG. 15 is an illustration of a third tear away use or function of suicide prevention door 60 of FIG. 7. FIG. 15 shows patient 90 grasping door 60 which is fully detached from first door jam 84 and second door jam 74. The third tear away use or function is shown from inside door frame 86. If patient 90 attempts to pull door 60 (or doors 10 and 40), due to the lack of anchor points, hinge component 70 and complementary attachment component 72, formed by VELCRO strips or other suitable components, and door latch component 82 and complementary latch component 80, formed by VELCRO strips or other suitable components, may readily allow detachment of door 60. Door 60 (and doors 10 and 40) are lightweight and have one or more hinge components made of VELCRO or another suitable material that can easily pull away when a predetermined weight is applied to the door.

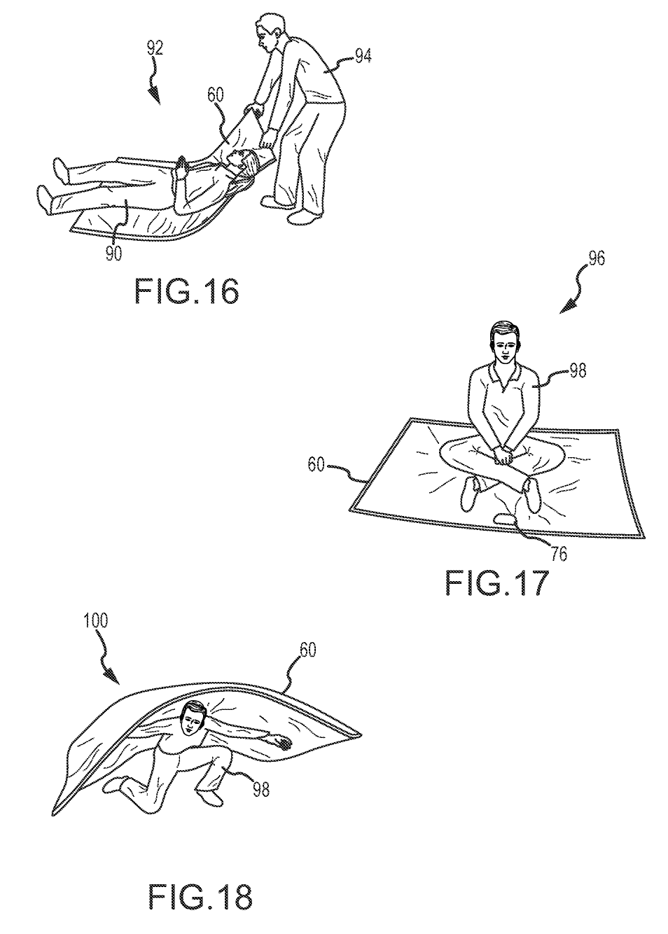

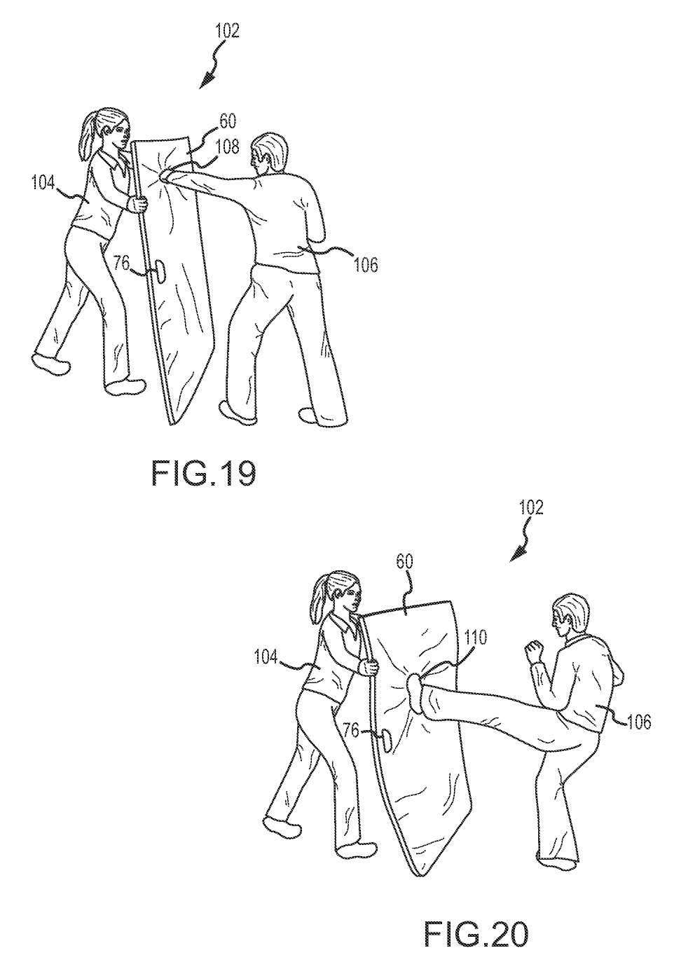

FIG. 16 is an illustration of an evacuation use 92 of suicide prevention door 60 of FIG. 7. Patient 90 may lay down on door 60 and a staff worker 94 may grasp and pull door 60 and move patient 90 laying on door 60 during an evacuation or emergency evacuation. FIG. 17 is an illustration of a mat use 96 of suicide prevention door 60 of FIG. 7. A user 98 may sit on door 60 and use it as a mat in case of evacuation or emergency evacuation. FIG. 18 is an illustration of a protection use 100 of suicide prevention door 60 of FIG. 7. User 98 may crouch below or underneath door 60, and door 60 may be used to protect user 98 from falling debris during a tornado or other emergency. FIG. 19 is an illustration of a self defense use 102 of suicide prevention door 60 of FIG. 7. A non-patient 104 may use door 60 as a barrier or shield to protect non-patient 104 from an aggressive patient 106 such as from a hand punch 108 by aggressive patient 106. FIG. 20 is an illustration of another self defense use 102 of suicide prevention door 60 of FIG. 7. Non-patient 104 may use door 60 as a barrier or shield to protect non-patient 104 from an aggressive patient 106 such as from a foot kick 110 by aggressive patient 106. Door 60 may also be used as a barrier or shield by non-patients to deflect items or fluids being thrown at them. Thus, door 60 (or doors 10 and 40), may be used, including but not limited to, uses for evacuation purposes, for protection from falling debris, and/or for use as a self defense tool or mechanism. Door 60 (or doors 10 and 40) may also be used for other suitable purposes. In another embodiment, door 60 (or doors 10 and 40) may also be used as a shower door or may be in the form of a saloon style door if the opening is very large. In the shower door embodiment of the suicide prevention door, a water curtain may be attached to the bottom of the shower door to prevent water from spraying out from underneath the shower door. The water curtain may comprise a breathable material that cannot be used by a patient to harm himself or herself.

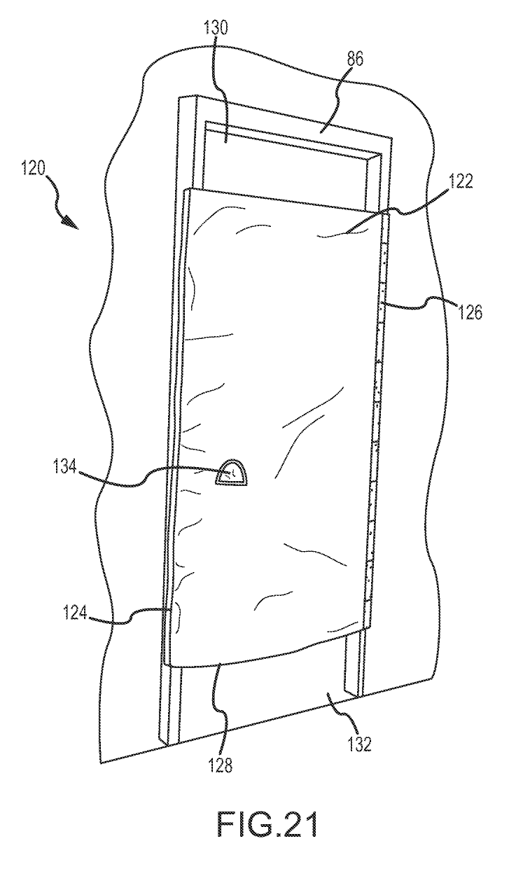

FIG. 21 is an illustration of a front perspective view of another embodiment of a suicide prevention door 120 according to the present invention. Suicide prevention door 120 is comprised of a fabric material 122 covering a sufficiently rigid insulation foam core component 124, and door 120 has no tubing around a frame 128 of door 120. Fabric material 122 may comprise a commercial lightweight vinyl, COVER LITE, vinyl laminated polyester, or another suitable lightweight material for providing stability to suicide prevention door 120. The fabric material, such as vinyl, may be laminated or adhered to both sides of the sufficiently rigid insulation foam core component, and the seams of the fabric material may be sealed with a waterproof, tamper proof sealant. The foam core component is preferably waterproof, infection control safe, sufficiently firm, and flame resistant. If needed, the foam core component may be wrapped with a lightweight batting material (not shown) to allow the foam core component to fit snugly within the fabric material with little or no movement. Suicide prevention door 120 further comprises a door handle 134. Door handle 134 is preferably stitched onto fabric material 122 and formed as shown. Suicide prevention door 120 further comprises a hinged side 140 (see FIG. 23) on a front side 138 of door 120 where hinged side 140 is comprised of VELCRO strips or another suitable material. The VELCRO may be cut into 6 inch strips along hinged side 140. VELCRO may be sewn on the appropriate side of the hinged side based on a desired door installation choice. Hinged side 140 may be attached to a complementary attachment component 126 (see FIG. 21) attached to a side on the outside of door frame 86. Complementary attachment component 126 may comprise complementary VELCRO strips. The VELCRO strips and complementary VELCRO strips may be cut to a predetermined length, such as 6 inches, for preventing use of the VELCRO strips as a rope or another such object for facilitating a suicide, such as if the VELCRO used for the door hinge was formed of a long VELCRO strip. In another embodiment, VELCRO may be attached or sewn onto plates (not shown) made of lightweight webbed material, lightweight metal, or another suitable material, and the plates may be attached to the outside of the door frame with tamper proof screws (not shown) so that the VELCRO does not continually pull off the door jams or door frame. As shown in FIG. 21, suicide prevention door 120 may be attached to the outside of door frame 86, so that suicide prevention door 120 may swing open and closed as a conventional door would open and close. In another embodiment door 120 may be attached to the inside of the door frame and the door leverages itself against the door frame to tear away from the door frame. The soft suicide prevention door is removable from the door jam when a predetermined weight is applied to release the hinge component from the complementary attachment component. In addition, suicide prevention door 120 may comprises a door latch component (not shown) on the back of door 120, where the door latch component may comprise one or more VELCRO strips or another suitable door latch component. The door latch component may be attached to a complementary latch contact (not shown) attached to the side of the door frame 86 opposite the side having the complementary attachment component 126. The complementary latch contact may comprise complementary VELCRO strips.

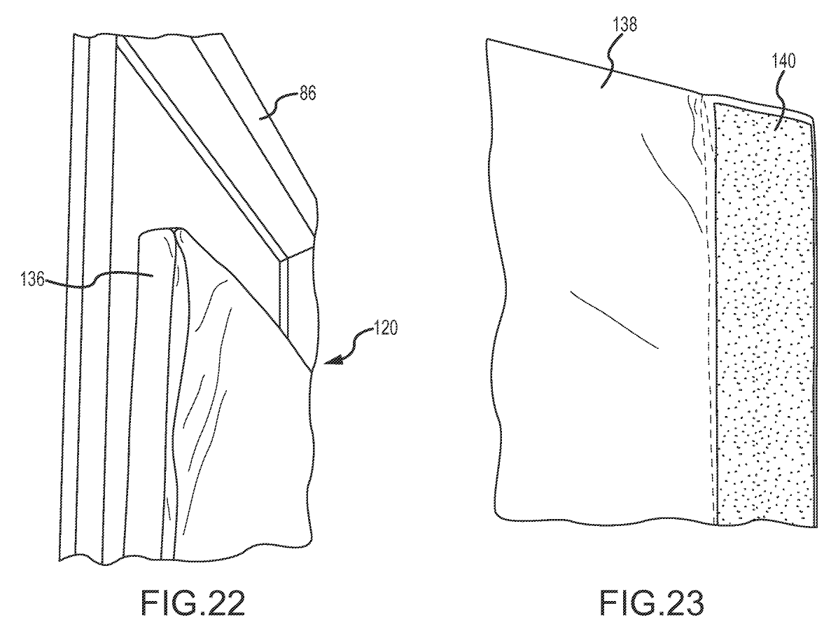

Suicide prevention door 120 has a top open space 130 above door 120 and a bottom open space 132 below door 120. Open spaces 130, 132 may each be approximately 8 inches in length. However, open spaces 130, 132 may be another suitable length depending on the size of door 120 used and the size of door frame 86. In a particular embodiment, door 120 may be about 5 feet long by 3.4 feet wide in size. However, door 120 may be another suitable size depending on the size of the door frame and doorway. FIG. 22 is an illustration of a close-up view of a front upper corner 136 of suicide prevention door 120 of FIG. 21. FIG. 23 is an illustration of a close-up view of hinged side 140 on front side 138 of suicide prevention door 120 of FIG. 21. FIG. 24 is an illustration of a close-up side cutaway view of another embodiment of a suicide prevention door 142 that is a variation of suicide prevention door 120 of FIG. 21. In this embodiment, suicide prevention door 142 is comprised of fabric material covering a form core component 42 and covering a tubing component 14 around the periphery of door 142.

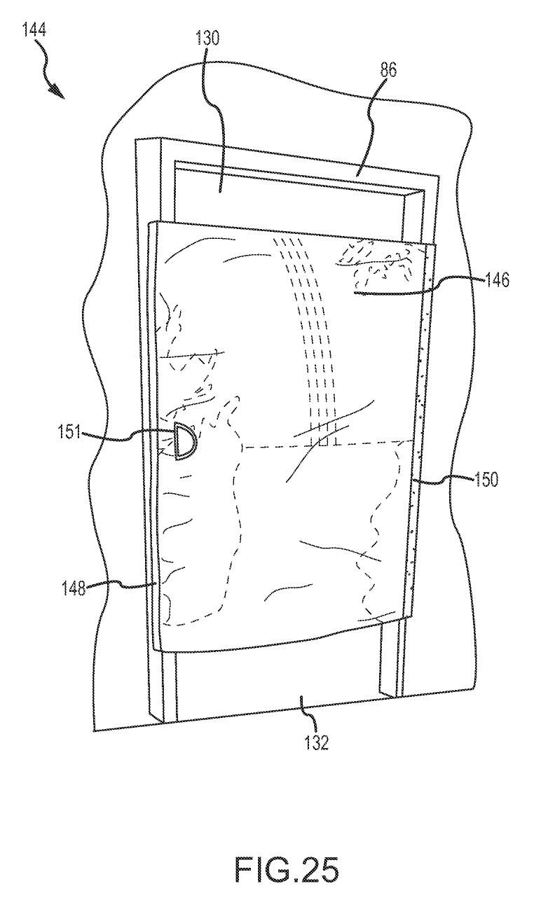

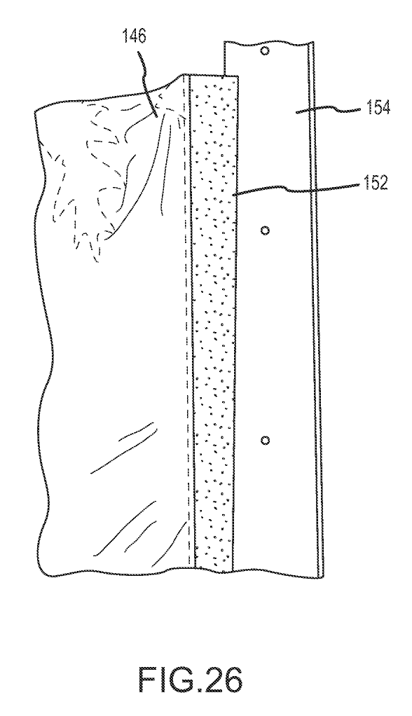

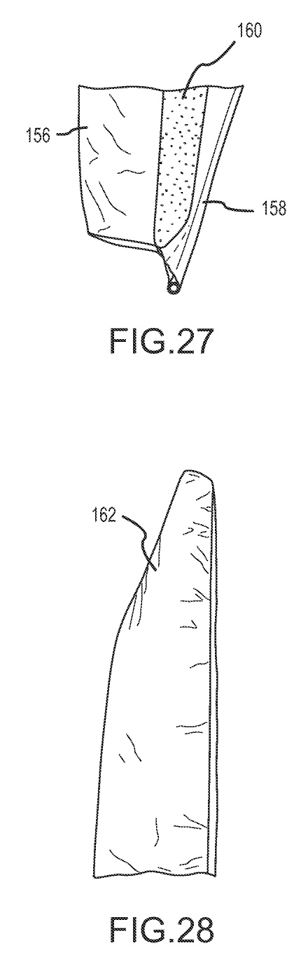

FIG. 25 is an illustration of a front perspective view of another embodiment of a suicide prevention door 144 according to the present invention. Suicide prevention door 144 is comprised of a graphic fabric material 146 covering a sufficiently rigid insulation foam core component 160 (see FIG. 27), and door 144 may have no tubing around a frame 148 of door 144. Optionally, door 144 may have tubing 158 (see FIG. 27) around the frame of door 144. Graphic fabric material 146 may comprise a commercial lightweight vinyl, COVER LITE, vinyl laminated polyester, or another suitable lightweight material for providing stability to suicide prevention door 144, and graphic fabric material 146 may have a scenic design or another suitable design or picture laminated onto graphic fabric material 146. The graphic fabric material, such as vinyl, may be laminated or adhered to both sides of the sufficiently rigid insulation foam core component, and the seams of the fabric material may be sealed with a waterproof, tamper proof sealant. The foam core component is preferably waterproof, infection control safe, sufficiently firm, and flame resistant. If needed, the foam core component may be wrapped with a lightweight batting material (not shown) to allow the foam core component to fit snugly within the fabric material with little or no movement. Suicide prevention door 120 further comprises a door handle 151. Door handle 151 is preferably made of graphic fabric material 146 and may be stitched or adhered onto graphic fabric material 146 and formed as shown. Suicide prevention door 144 further comprises a hinged side 152 (see FIG. 26) comprised of VELCRO strips or another suitable material. The VELCRO may be cut into 6 inch strips along hinged side 152. VELCRO may be sewn on the appropriate side of the hinged side based on a desired door installation choice. Hinged side 152 may be attached to a complementary attachment component 150 attached to a door jam 154 (see FIG. 30). The complementary attachment component 150 may comprise complementary VELCRO strips. The VELCRO strips and complementary VELCRO strips may be cut to a predetermined length, such as 6 inches, for preventing use of the VELCRO strips as a rope or another such object for facilitating a suicide, such as if the VELCRO used for the door hinge was formed of a long VELCRO strip. In another embodiment, VELCRO may be attached or sewn onto plates (not shown) made of lightweight webbed material, lightweight metal, or another suitable material, and the plates may be attached to the door frame with tamper proof screws (not shown) so that the VELCRO does not continually pull off the door jams or door frame. As shown in FIG. 30, the complementary attachment component 150 may be attached to the inside of door frame 86, so that door 144 may be attached to the inside of the door frame and the door leverages itself against the door frame to tear away from the door frame. Suicide prevention door 144 may also be attached to the outside of the door frame so that suicide prevention door 144 may swing open and closed as a conventional door would open and close. The soft suicide prevention door is removable from the door jam when a predetermined weight is applied to release the hinge component from the complementary attachment component.

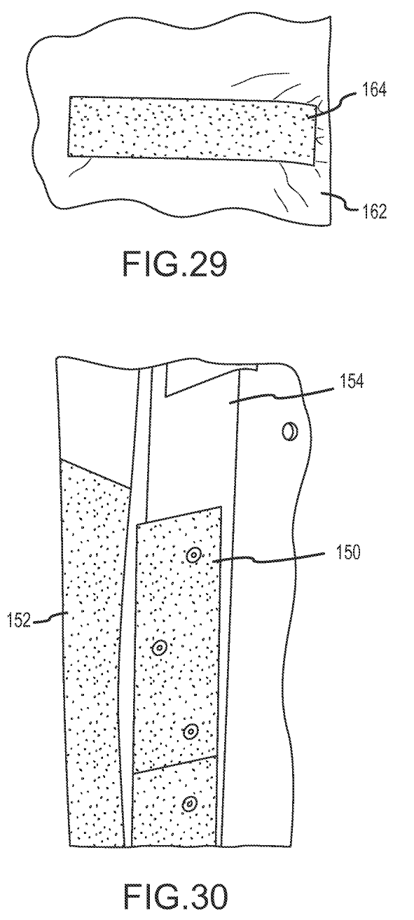

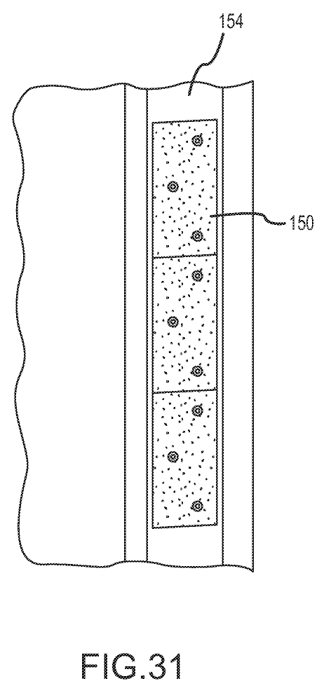

As shown in FIG. 25, suicide prevention door 144 has a top open space 130 above door 144 and a bottom open space 132 below door 144. The open spaces 130, 132 may each be approximately 8 inches in length. However, open spaces 130, 132 may be another suitable length depending on the size of door 144 used and the size of door frame 86. In an embodiment, door 144 may be about 5 feet long by 3.4 feet wide in size. However, door 144 may be another suitable size depending on the size of the door frame and doorway. FIG. 26 is an illustration of a close-up view of hinged side 152 of suicide prevention door 144 of FIG. 25. FIG. 27 is an illustration of a close-up view of a side lower corner 156 of suicide prevention door 144 of FIG. 25 showing foam core component 160 and optionally having tubing 158. FIG. 28 is an illustration of a close-up view of a back side 162 of suicide prevention door 144 of FIG. 25. FIG. 29 is an illustration of a close-up view of a door latch component 164 on back side 162 of suicide prevention door 144 of FIG. 25. Door latch component 164 may comprise one or more VELCRO strips or another suitable door latch component. Door latch component 164 may be attached to a complementary latch contact (not shown) attached to the side of door frame 86 opposite the side having complementary attachment component 150. The complementary latch contact may comprise complementary VELCRO strips. FIG. 30 is an illustration of a close-up view of hinged side 152 and complementary attachment component 150 attached to door jam 154 for suicide prevention door 144 of FIG. 25. FIG. 31 is an illustration of a close-up view of complementary attachment component 150 attached to door jam 154 for suicide prevention door 144 of FIG. 25.

Thus, the embodiments of the soft suicide prevention doors of the invention as discussed above provide for soft suicide prevention doors which do not have any anchor points, for which VELCRO, plastic, magnets, or other suitable means, act as the door hinge and/or door latch while the plastic packing sheet, insulation material and/or PVC tubing provide adequate structural strength while also providing sufficient flexibility to give and bend when pressure is applied. Due to the single piece construction of the embodiments of the suicide prevention doors discussed above, the doors may be readily disinfected after use to meet adequate cleanliness standards, and the VELCRO and vinyl material likewise meet fire and safety requirements for doors and such fixtures. The embodiments of the suicide prevention doors discussed above may be installed either inside a door frame and doorway or on the outside of a door frame and doorway.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A soft suicide prevention door comprising:
a door frame formed of a tubing component;
a fabric material disposed on opposed radial ends of the tubing component for forming a door body including an inner layer and an outer layer;
a foam core component disposed between the inner layer and the outer layer; and,
a hinge component attached to a side of the door body for forming a hinge when attached to a complementary attachment component attached to a door jam,
wherein the soft suicide prevention door is removable from the door jam when a predetermined weight is applied to release the hinge component from the complementary attachment component.

2. A soft suicide prevention door according to claim 1, wherein the tubing component comprises polyvinyl chloride (PVC) tubing.

3. A soft suicide prevention door according to claim 1, wherein the fabric material is selected from the group comprising lightweight vinyl and vinyl laminated polyester.

4. A soft suicide prevention door according to claim 1, wherein the fabric material comprises graphics laminated onto the fabric material.

5. A soft suicide prevention door according to claim 1, wherein the fabric material is laminated to a front side and a back side of the foam core component and any seams of the fabric material are sealed around the foam core component with a waterproof, tamper proof sealant.

6. A soft suicide prevention door according to claim 1, wherein the foam core component is selected from the group comprising rigid insulation foam and rigid plastic packing material.

7. A soft suicide prevention door according to claim 1, wherein the foam core component is waterproof, infection control safe, sufficiently firm, and flame resistant.

8. A soft suicide prevention door according to claim 1, wherein the hinge component is selected from the group comprising VELCRO strips, plastic and VELCRO attached with plastic rivets, and magnets.

9. A soft suicide prevention door according to claim 1, wherein the complementary attachment component is selected from the group comprising complementary VELCRO strips, webbed plates having complementary VELCRO strips attached to the webbed plates, metal plates having complementary VELCRO strips attached to the metal plates, and magnets.

10. A soft suicide prevention door according to claim 1, wherein the soft suicide prevention door further comprises a door handle made of the fabric material and attached to the outer layer of the door body.

11. A soft suicide prevention door according to claim 1, wherein the soft suicide prevention door further comprises a door latch component comprising one or more VELCRO strips, wherein the door latch component is attached to the inner layer of the door body.

12. A soft suicide prevention door according to claim 1, wherein the soft suicide prevention door has a use selected from the group comprising use as a suicide prevention door, use as a room door, use as a bathroom door, use as a shower door, use for evacuation during an emergency, use as a protection barrier, use as a self defense tool, and use in a mental health facility.

13. A soft suicide prevention door comprising:
a door frame formed of a rigid insulation foam core component covered by a lightweight fabric material; and,
a hinge component attached to a side of the door frame for forming a hinge when attached to a complementary attachment component attached to a door jam,
wherein the soft suicide prevention door is removable from the door jam when a predetermined weight is applied to release the hinge component from the complementary attachment component.

14. A soft suicide prevention door according to claim 13, wherein the lightweight fabric material is selected from the group comprising lightweight vinyl and vinyl laminated polyester.

15. A soft suicide prevention door according to claim 13, wherein the lightweight fabric material comprises graphics laminated onto the lightweight fabric material.

16. A soft suicide prevention door according to claim 13, wherein the rigid insulation foam core component is waterproof, infection control safe, sufficiently firm, and flame resistant.

17. A soft suicide prevention door according to claim 13, wherein the hinge component is selected from the group comprising VELCRO strips, plastic and VELCRO attached with plastic rivets, and magnets.

18. A soft suicide prevention door according to claim 13, wherein the complementary attachment component is selected from the group comprising complementary VELCRO strips, webbed plates having complementary VELCRO strips attached to the webbed plates, metal plates having complementary VELCRO strips attached to the metal plates, and magnets.

19. A soft suicide prevention door having no anchor points for a human to commit suicide, the door comprising:
a door frame formed of a polyvinyl chloride tubing component;
a lightweight vinyl fabric material disposed on opposed radial ends of the tubing component for forming a door body including an inner layer and an outer layer;
a foam core component disposed between the inner layer and the outer layer, wherein the foam core component is selected from the group comprising rigid insulation foam and rigid plastic packing material;
a hinge component comprising one or more VELCRO strips attached to a side of the door body for forming a hinge when attached to a complementary attachment component comprising one or more complementary VELCRO strips attached to a door jam;
a door handle made of the lightweight vinyl fabric material and attached to the outer layer of the door body; and,
a door latch component comprising one or more VELCRO strips, wherein the door latch component is attached to the inner layer of the door body;
wherein the soft suicide prevention door is removable from the door jam when a predetermined weight is applied to release the hinge component from the complementary attachment component.

20. A soft suicide prevention door according to claim 19, wherein the soft suicide prevention door has a use selected from the group comprising use as a suicide prevention door, use as a room door, use as a bathroom door, use as a shower door, use for evacuation during an emergency, use as a protection barrier, use as a self defense tool, and use in a mental health facility.
